(19) United States
(12) Patent Application Publication
(10) Pub. No.: US 2004/0119203 A1
(43) Pub. Date: Jun. 24, 2004

(54) Method for making plastic overcaps using hot runner back-gated mold technology

(75) Inventors: Earle Keirstead, North Redington Beach, FL (US); Fredrick S. McCleery, Clearwater, FL (US); William A. Conard, Harleysville, PA (US); Arthur G. Knight, Gulfport, FL (US); William C. Hoover, North East, PA (US); Thomas C. Butler, South Williamsport, PA (US); David D. Onzik, Muncy, PA (US)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: West Pharmaceutical Services, Inc.

(21) Appl. No.: 10/619,243

(22) Filed: Jul. 14, 2003

Related U.S. Application Data
(60) Provisional application No. 60/395,585, filed on Jul. 12, 2002.

(51) Int. Cl. B29C 45/40

(52) U.S. Cl. 264/328.1; 264/328.16; 264/334; 425/556; 425/549

(57) ABSTRACT

The present invention is a method for making a plastic overcap using a mold tool stack. The mold tool stack has a core and a cavity plate forming a cavity therebetween. The core has a resin passageway therein with a gate in a top surface of the core. The gate has a valve proximate the top surface of the core to regulate resin flowing from the resin passageway and into the cavity. The steps of the mold method are as follows: the mold tool stack is closed to form the cavity; the valve is opened to allow resin to enter the cavity; the valve is closed; the resin is allowed to cool; and the mold tool stack is opened to allow removal of the plastic overcap from within the mold tool stack. The top side of the plastic overcap produced is blemish-free, facilitating placement of labels and other markings thereon.

### CROSS-REFERENCE TO RELATED APPLICATIONS

This patent application claims priority to U.S. Patent Application No. 60/395,585, filed Jul. 12, 2002, entitled “Method For Making Plastic Overcaps Using Hot Runner Back-Gated Mold Technology,” the subject matter of which is incorporated herein by reference.

### BACKGROUND OF THE INVENTION

Removable protective closure systems for pharmaceutical products are generally known. U.S. Pat. No. 5,284,263 discloses a removable protective closure system for use with vials containing unit doses of medicaments, which is hereby incorporated by reference in its entirety. The closure system includes a rubber stopper, a cap seal and an overcap. Such closure systems are designed to be easily removed by a flipping motion of the thumb while the vial is held in one hand. The closure system also provide for pharmaceutical product identification which can be used at the point of application to ensure that the proper identification and other information is communicated to the nurse or other healthcare personnel.

Typically, production of molded plastic overcaps 100′ (FIG. 4) in the past has been accomplished using a cold runner top-gated mold technology (FIG. 2). Referring to FIGS. 2 and 4, the cold runner mold technology generally comprises a series of tooling component stacks 10′, each stack including a core 12′, a core plate 14′, a strip plate 16′, a cavity plate 20′, a runner plate 42′, a runner strip plate 32′, and a resin injector 34′. The core 12′ is fixedly engaged with the core plate 14′, rising above the core plate 14′. The top of the core 12′ generally forms the bottom of a mold area cavity 22′ for the molded plastic overcap 100′. Both the core 12′ and the core plate 14′ are stationary. The strip plate 16′ is movable and, during molding, is in facing engagement with the core plate 14′. The strip plate 16′ has a cylindrical opening through which the core 12′ projects. A strip plate bushing 18′ is maintained within the opening of the strip plate 16′ to ensure sealing engagement with the core 12′. The movable cavity plate 20′ is in facing engagement with the strip plate 16′ during molding. A small indentation is formed in the cavity plate 20′ to accommodate the top of the core 12′ and allow for a small void to be formed between the top of the core 12′ and the cavity plate 20′, thereby forming the mold area cavity 22′ for the molded plastic overcap 100′. A cavity plate tunnel 36′ is formed through the cavity plate 20′ and ending at the center of the indentation, at which point a top outside gate 24′ is formed. The gate 24′ forms a small opening into the mold area cavity 22′. The cavity plate tunnel 36′ gradually gets wider when moving from the gate 24′ to the top surface of the cavity plate 20′ culminating in a larger opening at the top of the cavity plate 20′. The runner plate 42′ is in facing engagement with the cavity plate 20′ during molding. The runner plate 42′ has a runner plate tunnel 38′ therethrough, which coincides with and continues from the opening at the larger end of the cavity plate tunnel 36′. The runner plate tunnel 38′ gets wider from the smaller opening in the bottom surface of the runner plate 42′ to the larger opening in the top surface of the runner plate 42′. The runner strip plate 32′ is in facing engagement with the runner plate 42′. The runner strip plate 32′ has a runner strip plate tunnel 40′ extending therethrough through which the resin injector 34′ is inserted. The runner strip plate tunnel 40′ is of a uniform width, which is slightly less than the width of the opening of the runner plate tunnel 38′ in the top surface of the runner plate 42′.

In order to manufacture multiple molded plastic overcaps 100′, multiple tooling component stacks 10′ are assembled as described above. The resin injectors 34′ of each stack are inserted within the runner strip plate tunnels 40′. Each resin injector 34′ releases heated plastic resin 28′ which flows through the runner plate tunnel 38′ and the cavity plate tunnel 36′, passing through the gate 24′ and filling the mold area cavity 22′. The resin injectors 34′ are then removed and the plastic resin 28′ is left to cool. Cooling is accelerated using water lines 30′ that run through the cavity plate 20′ and the core 12′. Cool water is circulated through the water lines 30′ to absorb heat from the cavity plate 20′ and the core 12′ which have absorbed heat from the heated resin 28′. Upon sufficient cooling, the runner strip plate 32′ and the runner plate 42′ are removed from engagement with the cavity plate 20′. Due to the tapered walls of the runner plate tunnel 38′, this movement exerts stress on the excess solidified resin that has collected within the runner plate tunnel 38′ and the cavity plate tunnel 36′. The excess resin breaks off at the point of its smallest cross-sectional area at the gate 24′, thereby severing the excess resin from the molded plastic overcap 100′. The excess resin is then collected to be recycled and subsequently reused. The cavity plate 20′ is then removed from engagement with the strip plate 16′ exposing a top side 102′ of the molded plastic overcap 100′. The strip plate 16′ is then removed from engagement with the core plate 14′, whereupon the strip plate bushing 18′ pushes upon a bottom side 106′ of an outside edge 104′ of the molded plastic overcap 100′ in order to remove the molded plastic overcap 100′ from the top of the core 12′. Pressurized air from an air line 32′ is also directed at the molded plastic overcap 100′ to facilitate its release from the top of the core 12′. The molded plastic overcap 100′, now released from the mold area cavity 22′, falls into a collection receptacle (not shown).

There are several drawbacks inherent to the cold runner top-gated molding process of the prior art. First, because of the location of the gate 24′, when the excess resin is removed, a small protrusion 103′ of excess resin remains at the breakage point extending outwardly from the top side 102′ of the molded plastic overcap 100′. The protrusion 103′ presents problems when placing a label on or otherwise marking the top of the molded plastic overcap 100′. Second, the design of the cold runner top-gated mold technology requires the presence of the excess resin (known as a runner) during the production of each molded plastic overcap 100′. This necessitates the removal and recycling of the excess resin for its subsequent reuse. This process inevitably results in the loss of plastic resin. Third, because the process requires cooling time and subsequent removal of the excess resin runner before a finished molded plastic overcap 100′ is produced, the cycle time for the cold runner top-gated mold technology is relatively lengthy.

The present invention comprises a process for making molded plastic overcaps using a hot runner back-gated mold which seeks to remedy the drawbacks of the cold runner top-gated mold technology. First, because the gate is now located at the back of the mold area, the small protrusion of excess resin gate vestige is now located on the back side of the molded plastic overcap, instead of the top side, thereby enabling the overcap to be manufactured with a flat top free from blemishes, making it easier to affix labels, custom logos, and other identification devices such as electronic or magnetic devices to or otherwise mark the top side of the overcap. Second, because the plastic resin remains in liquid form during the entire molding process, no runners are formed, and, consequently, there is no excess resin to be recycled, resulting in material savings. Third, because the process requires no cooling time and no evacuation of excess resin runners, the hot runner back-gated mold can be run at higher speeds, cutting the cycle time to less than half that of the cold runner top-gated mold.

### BRIEF SUMMARY OF THE INVENTION

Briefly stated, in one aspect, the present invention comprises a mold tool stack for making plastic overcaps from heated resin. The mold tool stack comprises a core, a cavity plate, and a resin passageway. The cavity plate is located above the core. One of the core and the cavity plate is axially movable relative to the other of the core and the cavity plate to allow the core and the cavity plate to engage with each other when the mold tool stack is in a closed position and to allow the core and the cavity plate to separate from each other when the mold is in an open position. When the mold tool stack is in the closed position, a cavity is formed between a top surface of the core and a portion of a bottom surface of the cavity plate. The portion of the bottom surface of the cavity plate corresponds to a top side of the plastic overcap. The top surface of the core corresponds to a bottom side of the plastic overcap. The portion of the bottom surface of the cavity plate is substantially flat and blemish-free. A resin passageway is located within the core with a gate in the top surface of the core. The gate has a valve proximate the top surface of the core to regulate heated resin flowing out of the resin passageway and into the cavity. The valve is proximate the top surface of the core. This allows for minimal wasted resin between the valve and the plastic overcap and further allows for a gate mark to be present on the bottom side of the plastic overcap to allow for the top side of the plastic overcap to be substantially flat and blemish-free.

In another aspect, the present invention comprises a method for making a plastic overcap using a mold tool stack. The mold tool stack has a core and a cavity plate forming a cavity therebetween. The core forms a bottom of the cavity and the cavity plate forms a top of the cavity, such that the top of the cavity corresponds to a top side of the plastic overcap and the bottom of the cavity corresponds to a bottom side of the plastic overcap. The core has a resin passageway therein with a gate in a top surface of the core. The gate has a valve proximate the top surface of the core to regulate an amount of resin flowing out of the resin passageway and into the cavity. One of the core and the cavity plate is axially movable relative to the other of the core and the cavity plate. The steps of the mold method are as follows. First, the mold tool stack is closed such that the core is in contact with the cavity plate to form the cavity therebetween. Second, the valve is opened to allow resin to enter the cavity. Third, the valve is closed to stop the flow of resin into the cavity once a desired amount of resin has entered the cavity. Fourth, the resin within the cavity is allowed to cool to form the plastic overcap. Fifth, the mold tool stack is opened to allow removal of the plastic overcap from within the mold tool stack, such that the plastic overcap produced has a small protrusion of excess resin on the bottom side due to the proximity of the valve to the top surface of the core. This allows the top side of the plastic overcap to be blemish-free to facilitate placement of labels and other markings thereon.

In another aspect, the present invention comprises a plastic overcap for use with a closure system for sealing medicament containers. The plastic overcap comprises a single circular disk having a top side, a bottom side, and a side skirt extending downwardly from the outside edge of the bottom side. The top side is substantially flat and blemish-free to facilitate writing on or placement of labels on the top side of the plastic overcap in order to properly identify a medicament within the medicament container. The bottom side has a small cylindrical ring extending downwardly from the bottom side. The plastic overcap further has a gate mark on the bottom side inside the cylindrical ring. The gate mark is on the bottom side so as not to disrupt the substantially flat and blemish-free top side.

### BRIEF DESCRIPTION OF THE SEVERAL VIEWS OF THE DRAWINGS

The foregoing summary, as well as the following detailed description of preferred embodiment of the invention, will be better understood when read in conjunction with the appended drawings. For the purpose of illustrating the invention, there is shown in the drawings an embodiment which are presently preferred. It should be understood, however, that the invention is not limited to the precise arrangements and instrumentalities shown.

In the drawings:

FIG. 1 is a sectional elevational view of a tooling component stack of a hot runner back-gated mold in accordance with a preferred embodiment of the present invention;

FIG. 2 is a sectional elevational view of a tooling component stack of a cold runner top-gated mold of the prior art;

FIG. 3 is a perspective view of a molded plastic overcap manufactured using the tool component stack and the process of the present invention;

FIG. 4 is a perspective view of a molded plastic overcap manufactured using the process of the prior art;

FIG. 5a is a sectional elevational view of the tooling component stack of FIG. 1 in a closed position with an empty cavity;

FIG. 5b is a sectional elevational view of the tooling component stack of FIG. 1 in a closed position with a resin-filled cavity;

FIG. 5c is a sectional elevational view of the tooling component stack of FIG. 1 in a partly open position;

FIG. 5d is a sectional elevational view of the tooling component stack of FIG. 1 in a fully open position; and

FIG. 5e is a sectional elevational view of the tooling component stack of FIG. 1 in a fully open position with air being forced from air lines to eject a molded plastic overcap.

### DETAILED DESCRIPTION OF THE INVENTION

Certain terminology is in the following description for convenience only and is not limiting. The words “right”, “left”, “upper”, and “lower” designate directions in the drawings to which reference is made. The terminology includes the words above specifically mentioned, derivatives thereof, and words of similar import.

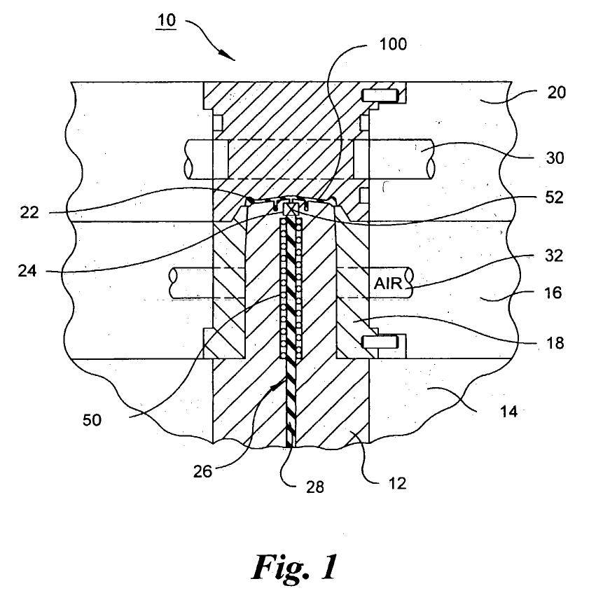

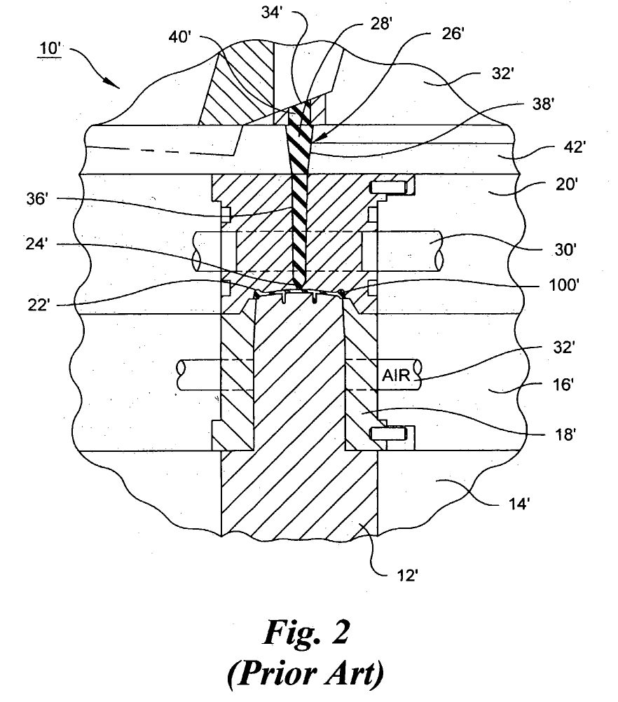

Referring to the drawings in detail, wherein like numerals indicate like elements throughout, there is shown in FIG. 1 a preferred embodiment of a hot runner back-gated mold tool stack, indicated generally at 10, in accordance with the present invention. It is preferred that the present invention has a plurality of tool stacks 10 in order to increase production, and, although only a single tool stack 10 is described below, all tool stacks 10 of the present invention are substantially similar. The tool stack 11 has a core, 12, a core plate 14, a strip plate 16, a strip plate bushing 18, and a cavity plate 20, all of which are made of a high strength, light weight material such as tool steel, for example. The core 12 is fixedly maintained within an opening in the core plate 14. The core 12 forms a generally cylindrical protrusion extending upwardly from a top surface of the core plate 14. Preferably, both the core 12 and the core plate 14 are stationary.

The strip plate 16 is in facing engagement with the core plate 14. The strip plate 16 is movable in a vertical direction and has an opening therethrough to accommodate the core 12 when in facing engagement with the core plate 14. The strip plate bushing 18 is maintained within the opening in the strip plate 16 in order to ensure a sealing engagement with the core 12.

The cavity plate 20 is in facing engagement with the strip plate 16. The cavity plate 20 has an indentation in a bottom surface in order to accommodate the amount of the core 12 that extends beyond a top surface of the strip plate 16. The cavity plate 20 is movable in the vertical direction.

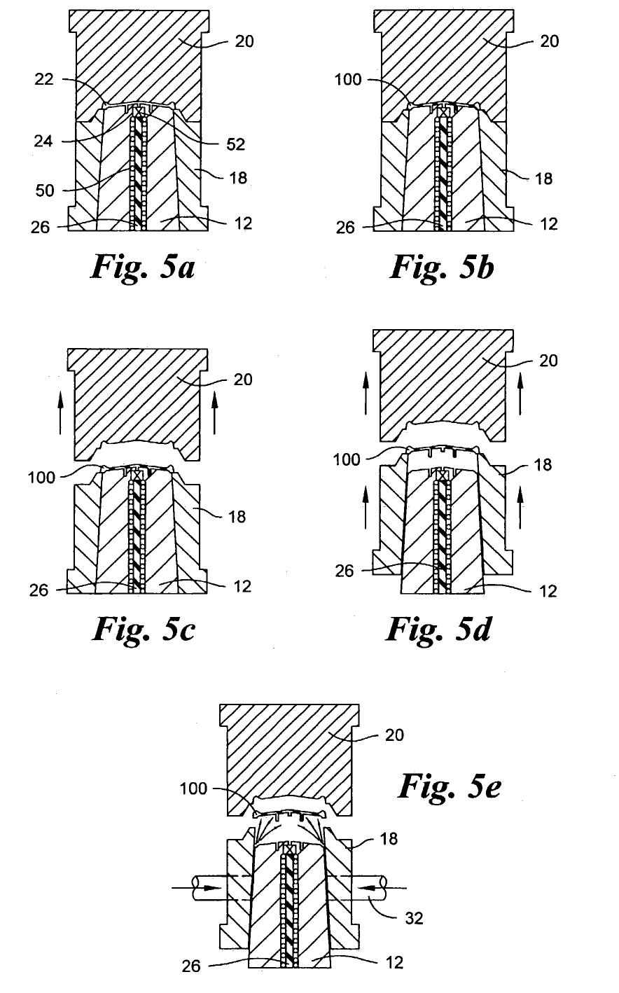

The tool stack 10 is in a closed position (FIG. 5a) when the cavity plate 20 and the strip plate 16 and strip plate bushing 18 are stacked in their respective lowest positions. The tool stack 10 is in an open position (FIG. 5e) when the cavity plate 20 and the strip plate 16 and strip plate bushing 18 are raised to their respective highest positions above the core 12.

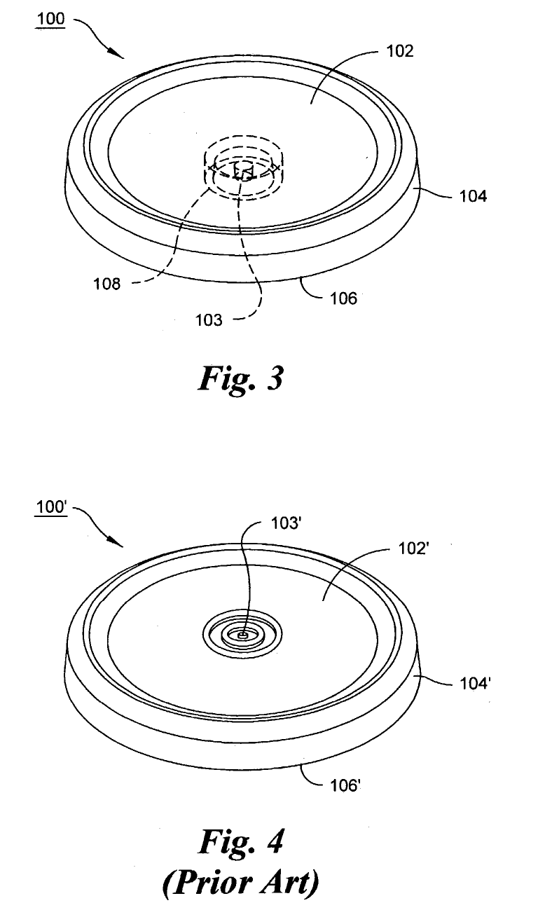

When in the closed position, a small mold area cavity 22 is formed by the tool stack 10 between a portion of the bottom surface of the cavity plate 20 and a top surface of the core 12, within which a molded plastic overcap 100 is formed for each cycle of the tool stack 10. The portion of the bottom surface of the cavity plate 20 corresponds to a top side 102 of the plastic overcap 100 (FIG. 3), and the top surface of the core 12 corresponds to a bottom side 106 of the plastic overcap 100.

Within the core 12 is a resin passageway 26 leading from a resin source (not shown) to the mold area cavity 22. The resin passageway 26 is preferably located through the center of the core 12. A plastic resin 28 enters the mold area cavity 22 from the resin passageway 26 through a gate 24 at the top surface of the core 12, preferably in the center of the top surface of the core 12. A valve 52 is within the gate 24 to regulate the amount of resin 28 flowing out of the resin passageway 26 and into the mold area cavity 22. The valve 52 is proximate the top surface of the core 12 to allow for minimal wasted resin 28 between the valve 52 and the plastic overcap 100. The placement of the valve 52 proximate the top surface of the core 12 further allows for a gate mark to be present on the bottom side 106 of the plastic overcap 100 to allow the top side 102 of the plastic overcap 100 to be substantially flat and blemish-free. Heating coils 50 are preferably located around the resin passageway 26 up to the gate 24 in order to keep the resin 28 within the resin passageway 26 heated at all times throughout a mold cycle.

Air jets 32 are preferably located within the strip plate bushing 18, although it is within the spirit and scope of the present invention for the air jets 32 to be located within the core 12. Air is forcibly ejected from the airjets 32 and directed against the bottom side 106 of the plastic overcap 100 to facilitate removal of the plastic overcap 100 from within the tool stack 10 at the end of the mold cycle (FIG. 5e).

At least one tube 30 is located within the cavity plate 20 through which cool water or other fluid flows in order to keep the cavity plate 20 cool and subsequently facilitate the cooling of the resin 28 within the mold area cavity 22 during the mold cycle. Although only one tube 30 is portrayed, it is within the spirit and scope of the present invention that there be a network of tubes 30 located within the cavity plate 20 in order to more evenly and more quickly cool the resin 28 within the mold area cavity 22 at the end of the mold cycle.

In operation, referring to FIGS. 1, 3, and 5a-5e, the tool stack 10 is assembled as described above in the closed position (FIG. 5a). The valve 52 is opened in the resin passageway 26, allowing heated resin 28 to pass from the resin source through the gate 24 and into the mold area cavity 22. Upon filling of the mold area cavity 22, the valve 52 is closed, cutting off the flow of resin 28 at the gate 24, as seen in FIG. 5b. The tubes 30 through the cavity plate 20 circulate cool water or other fluid throughput the tooling stack 10 in order to keep the mold area cavity 22 cool. The heating coils 50 immediately below the gate 24 around the resin passageway 26 keep the resin 28 heated. In this way, the resin 28 within the mold area cavity 22 cools quickly, while the resin 28 remaining within the resin passageway 26 remains heated. Referring specifically to FIG. 5c, the cavity plate 20 is then raised vertically from the strip plate 16 and strip plate bushing 18, opening the mold area cavity 22 and exposing the top side 102 of the molded plastic overcap 100 formed within. Referring now to FIG. 5d, both the strip plate 16 and the cavity plate 20 are raised vertically from the core 12 such that the tool stack 10 is in the open position. In so doing, the strip plate bushing 18 engages with a bottom of a side skirt 104 of the molded plastic overcap 100 pushing the plastic overcap 100 and removing it from engagement with the top surface of the core 12. Removal of the overcap 100 from within the tool stack 10 is facilitated by air forcibly ejected from the air jets 32 and directed against the bottom side 106 of the plastic overcap 100. The finished plastic overcap 100 then drops from the tool stack 10 into a waiting collection-receptacle (not shown). The cavity plate 20, the strip plate 16, and the strip plate bushing 18 are then lowered into a stack to place the tool stack 10 in the closed position, and the mold cycle is repeated.

Referring now to FIG. 3, the plastic overcap 100 produced with the tool stack 10 of the present invention is comprised of a single circular disk having the top side 102, the bottom side 106, and the side skirt 104. The side skirt 104 extends downwardly from the outside edge of the bottom side 106. The top side 102 is substantially flat and blemish-free to facilitate writing on or placement of labels on the top side 102 of the plastic overcap 100 in order to properly identify a medicament within a medicament container (not shown). The bottom side 106 has a small cylindrical ring 108 extending downwardly therefrom. Although it is preferable that the cylindrical ring 108 be located at the center of the bottom side 106 of the plastic overcap 100, it is within the spirit and scope of the present invention for the cylindrical ring 108 to be located anywhere on the bottom side 106. The cylindrical ring 108 is appropriately sized to insert into and engage with an opening in the cap seal, in a manner well understood by those of ordinary skill in the art. Extending slightly downwardly from the bottom side 106 within the cylindrical ring 108, the plastic overcap 100 has a gate mark 103, in the form of a small protrusion (shown in phantom in FIG. 3). The gate mark 103 is on the bottom side 106 of the plastic overcap 100 so as not to disrupt the substantially flat and blemish-free top side 102. Also, the gate mark 103 is preferably inside the cylindrical ring 108 so as to be out of contact with the cap seal in order to avoid improper sealing of the medicament container. Although the plastic overcap 100 of the present invention is used with a closure system preferably for the sealing of medicament containers, it is within the spirit and scope of the present invention that the plastic overcaps 100 be used with closure systems for the sealing of different types of containers and is not limited to medicament containers.

The hot runner back-gated mold tool stack 10 of the present invention overcomes several problems inherent in the prior art. First, the location of the gate 24 allows the mold area 22 to be filled with resin 28 from the back, causing the gate mark 103 of excess resin 28 to form on the bottom side 106 of the plastic overcap 100. This allows the top side 102 to be free from blemishes so that labels and other markings can be more easily affixed thereto. Second, because the resin 28 remains heated and in liquid form within the resin passageway 26 and because the valve 52 cuts off the supply of resin 28 immediately proximate the mold area cavity 22, there are no excess resin runners to be recycled and reused, resulting in material savings. Third, because there is little required cooling time and no evacuation of excess resin runners required, the tool stack 10 can be run at higher speeds than was possible in the prior art, resulting in cycle times of the present invention that are less than half those of the prior art.

It will be appreciated by those skilled in the art that changes could be made to the embodiment described above without departing from the broad inventive concept thereof. It is understood, therefore, that this invention is not limited to the particular embodiment disclosed, but it is intended to cover modifications within the spirit and scope of the present invention.

We claim:

1. A mold tool stack for making plastic overcaps from heated resin, the mold tool stack comprising:
a core;
a cavity plate located above the core, one of the core and the cavity plate being axially movable relative to the other of the core and the cavity plate to allow the core and the cavity plate to engage with each other when the mold tool stack is in a closed position and to allow the core and the cavity plate to separate from each other when the mold is in an open position, when the mold tool stack is in the closed position a cavity is formed between a top surface of the core and a portion of a bottom surface of the cavity plate, the portion of the bottom surface of the cavity plate corresponds to a top side of the plastic overcap and the top surface of the core corresponds to a bottom side of the plastic overcap, the portion of the bottom surface of the cavity plate being substantially flat and blemish-free; and
a resin passageway located within the core with a gate in the top surface of the core, the gate having a valve proximate the top surface of the core to regulate heated resin flowing out of the resin passageway and into the cavity, wherein the valve being proximate the top surface of the core allows for minimal wasted resin between the valve and the plastic overcap and further allows for a gate mark to be present on the bottom side of the plastic overcap to allow for the top side of the plastic overcap to be substantially flat and blemish-free.

2. The mold tool stack of claim 1 wherein the resin passageway is centrally located within the core with the gate being in the center of the top surface of the core.

3. The mold tool stack of claim 1 further comprising a strip plate bushing that circumscribes the core and moves upwardly relative to the core, the strip plate bushing forming an outer bottom surface of the cavity, the upward movement of the strip plate bushing acting to lift the plastic overcap off of the top surface of the core to facilitate removal of the plastic overcap from within the mold tool stack.

4. The mold tool stack of claim 3 further comprising air jets located in one of the core and the strip plate bushing to allow for the forcible ejection of air against the bottom side of the plastic overcap to facilitate removal of the plastic overcap from within the mold tool stack.

5. The mold tool stack of claim 1 further comprising at least one tube within the cavity plate through which cool fluid flows in order to accelerate the cooling of the resin within the cavity.

6. The mold tool stack of claim 1 further comprising heating coils around the resin passageway to keep the resin within the passageway heated.

7. A method for making a plastic overcap using a mold tool stack, the mold tool stack having a core and a cavity plate forming a cavity therebetween, the core forming a bottom of the cavity and the cavity plate forming a top of the cavity, such that the top of the cavity corresponds to a top side of the plastic overcap and the bottom of the cavity corresponds to a bottom side of the plastic overcap, the core having a resin passageway therein with a gate in a top surface of the core, the gate having a valve proximate the top surface of the core to regulate an amount of resin flowing out of the resin passageway and into the cavity, one of the core and the cavity plate being axially movable relative to the other of the core and the cavity plate, the mold method comprising the steps of:
closing the mold tool stack such that the core is in contact with the cavity plate to form the cavity therebetween;
opening the valve to allow resin to enter the cavity;
closing the valve to stop the flow of resin into the cavity once a desired amount of resin has entered the cavity;
allowing the resin within the cavity to cool to form the plastic overcap; and
opening the mold tool stack to allow removal of the plastic overcap from within the mold tool stack, such that the plastic overcap produced has a small protrusion of excess resin on the bottom surface due to the proximity of the valve to the top surface of the core, thereby allowing the top side of the plastic overcap to be blemish-free to facilitate placement of labels and other markings thereon.

8. The mold method of claim 7 wherein the mold tool stack has a strip plate bushing that circumscribes the core and moves upwardly relative to the core, the strip plate bushing forming an outer bottom surface of the cavity, the mold method further comprising the step of upward-movement of the strip plate bushing to lift the plastic overcap off of the top surface of the core to facilitate the removal of the plastic overcap from within the mold tool stack.

9. The mold method of claim 8 wherein the mold tool stack has air jets located in one of the core and the strip plate bushing, the mold method further comprising the step of forcible ejection of air out of the air jets and against the bottom side of the plastic overcap to facilitate the removal of the plastic overcap from within the mold tool stack.

10. The mold method of claim 7 further comprising the step of circulating cool fluid through at least one tube within the cavity plate in order to accelerate the cooling of the resin within the cavity.

11. The mold method of claim 7 further comprising the step of heating coils around the resin passageway in order to keep the resin within the passageway heated.

12. A plastic overcap for sealing medicament containers, the plastic overcap comprising a single circular disk having a top side, a bottom side, and a side skirt extending downwardly from the outside edge of the bottom side, the top side being substantially flat and blemish-free to facilitate writing on or placement of labels on the top side of the plastic overcap in order to properly identify a medicament within the medicament container, the bottom side having a small cylindrical ring extending downwardly from the bottom side, the plastic overcap further having a gate mark on the bottom side inside the cylindrical ring, the gate mark being on the bottom side so as not to disrupt the substantially flat and blemish-free top side.

13. The plastic overcap of claim 12 wherein the small cylindrical ring extends downwardly from the center of the bottom side.
